(19) United States
(12) Patent Application Publication
(10) Pub. No.: US 2025/0244619 A1
(43) Pub. Date: Jul. 31, 2025

(54) DISPLAY DEVICE

(71) Applicant: DARWIN PRECISIONS CORPORATION, Hsinchu County (TW)

(72) Inventors: CHIH-PING HSU, Hsinchu County (TW); SYUAN-WEI JHANG, Hsinchu County (TW); WEI CHEN, Hsinchu County (TW)

(21) Appl. No.: 19/021,280

(22) Filed: Jan. 15, 2025

(30) Foreign Application Priority Data
Jan. 30, 2024 (TW) 113103593

(51) Int. Cl. G02F 1/13; G02F 1/1335

(52) U.S. Cl. CPC G02F 1/1323; G02F 1/133526

(57) ABSTRACT

A display device includes a display assembly and a microlens array. The display assembly is provided with a plurality of display areas, each of the display areas is divided into a plurality of sub-display areas, each of the sub-display areas includes an information-displaying part and an information-shielding part, and the information-shielding part is located beside the information-displaying part. The microlens array is disposed opposite to the display assembly, and the microlens array includes a plurality of microlenses that are respectively opposite to the plurality of sub-display areas. This display device has an anti-peeping effect in consideration of both an appearance and the display effect.

### FIELD OF THE INVENTION

The invention relates to a display device, and more particularly to a display device with an anti-peeping effect.

### BACKGROUND OF THE INVENTION

With the popularization of science and technology, various operating machines can be seen everywhere in daily life, such as parking payment machines, self-service book-borrowing machines, and automated teller machines (ATMs). Because such machines are usually disposed in public places for use by unspecified objects, if personal information or confidential information needs to be input, users need to cover buttons with gestures to prevent information leakage, but this will cause inconvenience in use. To reduce the inconvenience in use, machine manufacturers will adjust the appearance of the machines (such as adding grilles). However, the adjustment will affect the appearances of the machines.

### SUMMARY OF THE INVENTION

The invention provides a display device with an anti-peeping effect.

The display device provided in the invention includes a display assembly and a microlens array. The display assembly is provided with a plurality of display areas, each of the display areas is divided into a plurality of sub-display areas, each of the sub-display areas includes an information-displaying part and an information-shielding part, and the information-shielding part is located beside the information-displaying part. The microlens array is disposed opposite to the display assembly. The microlens array includes a plurality of microlenses, which are respectively opposite to the plurality of sub-display areas.

In an embodiment of the invention, the display assembly includes a display panel, the display panel is provided with the plurality of display areas, and the information-displaying part and the information-shielding part respectively include a plurality of pixels.

In an embodiment of the invention, the display assembly further includes a backlight module that is disposed opposite to the display panel.

In an embodiment of the invention, the display assembly includes a backlight module and an imaging sheet, the imaging sheet is disposed between the microlens array and the backlight module, and the imaging sheet is provided with a plurality of display areas.

In an embodiment of the invention, the display assembly further includes a shielding layer disposed between the imaging sheet and the backlight module. The shielding layer is provided with a plurality of shielding patterns, and the plurality of shielding patterns are respectively opposite to the plurality of information-shielding parts of the plurality of sub-display areas.

In an embodiment of the invention, the display assembly further includes a shielding layer disposed between the imaging sheet and the microlens array. The shielding layer is provided with a plurality of shielding patterns, and the plurality of shielding patterns are respectively opposite to the plurality of information-shielding parts of the plurality of sub-display areas.

In an embodiment of the invention, the display assembly further includes a shielding layer disposed on one side that is of the microlens array and that is away from the imaging sheet. The shielding layer is provided with a plurality of shielding patterns, and the plurality of shielding patterns are respectively opposite to the plurality of information-shielding parts of the plurality of sub-display areas.

In an embodiment of the invention, the information-shielding part of each of the sub-display areas is provided with a light-shielding pattern.

In an embodiment of the invention, the information-shielding part is disposed beside at least one side of the information-displaying part.

In an embodiment of the invention, the information-shielding part surrounds the information-displaying part.

The sub-display area including the information-displaying part and the information-shielding part is used for the display device in the invention, and the viewing angle can be reduced by using the information-shielding part so that the anti-peeping effect can be achieved.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 is a schematic side view of a display device according to an embodiment of the invention;

FIG. 2 is a schematic top view of a display assembly in FIG. 1;

FIG. 3 is a schematic diagram of a single sub-display area in FIG. 2;

FIG. 4 is a schematic side view of a microlens corresponding to the single sub-display area in FIG. 3;

FIG. 5 is a schematic diagram of a single sub-display area according to another embodiment of the invention;

FIG. 6 is a schematic diagram of a single sub-display area according to another embodiment of the invention;

FIG. 7 is a schematic diagram of a single sub-display area according to another embodiment of the invention;

FIG. 8 is a schematic side view of a display device according to another embodiment of the invention;

FIG. 9 is a schematic side view of a display device according to another embodiment of the invention;

FIG. 10 is a partially enlarged schematic diagram of the display device shown in FIG. 9;

FIG. 11 is a schematic side view of a display device according to another embodiment of the invention; and

FIG. 12 is a schematic side view of a display device according to another embodiment of the invention.

### DETAILED DESCRIPTION OF PREFERRED EMBODIMENTS

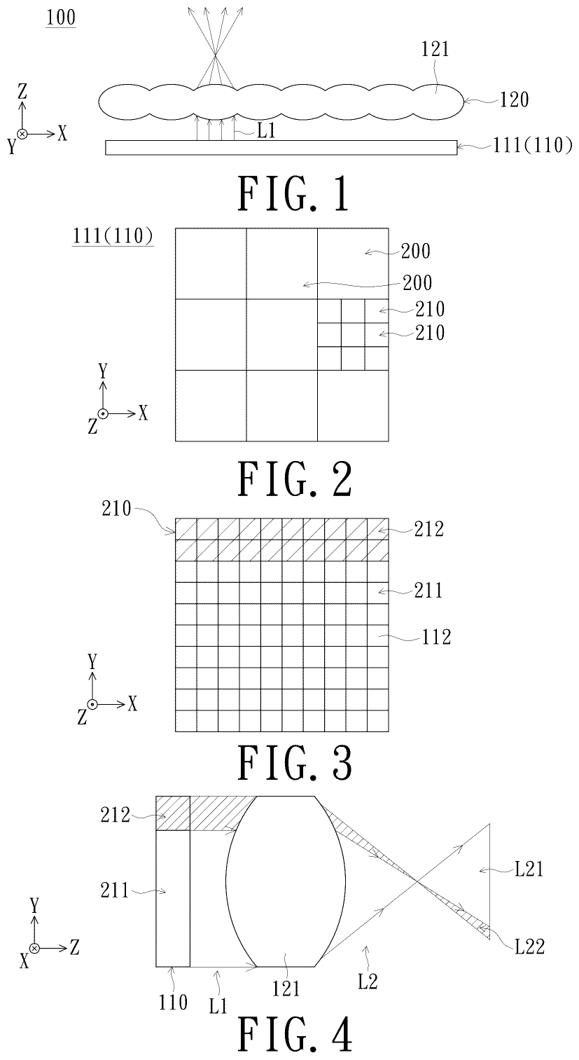

FIG. 1 is a schematic side view of a display device according to an embodiment of the invention. FIG. 2 is a schematic top view of a display assembly in FIG. 1. Refer to FIG. 1 and FIG. 2. The display device 100 provided in this embodiment includes a display assembly 110 and a microlens array 120. The display assembly 110 is provided with a plurality of display areas 200, and each display area 200 is divided into a plurality of sub-display areas 210. The microlens array 120 is disposed opposite to the display assembly 110. The microlens array 120 includes a plurality of microlenses 121, which are respectively opposite to the sub-display areas 210.

Specifically, the microlens array 120 is suitable for projecting an image light beam L1 provided by the display assembly 110 to a side of the microlens array 120 away from the display assembly 110 to form a floating image (not shown). The microlenses 121 of the microlens array 120 are, for example, biconvex lenses or plano-convex lenses, but the invention is not limited thereto. In this embodiment, the display areas 200 are, for example, arranged in an array, and the sub-display areas 210 in each display area 200 are arranged, for example, in an array, but the invention is not limited thereto.

FIG. 3 is a schematic diagram of a single sub-display area in FIG. 2. FIG. 4 is a schematic side view of a microlens corresponding to the single sub-display area in FIG. 3. Refer to FIG. 3 and FIG. 4. In this embodiment, each microlens 121 is opposite to a sub-display area 210 so the arrangement manner of the sub-display areas 210 corresponds to the arrangement manner of the microlenses 121; that is, the microlenses 121 are also, for example, arranged in an array. Continuing from the above, in this embodiment, each sub-display area 210 includes an information-displaying part 211 and an information-shielding part 212. The information-shielding part 212 is located beside the information-displaying part 211. Specifically, the information-shielding part 212 in this embodiment is, for example, located on a side edge of the information-displaying part 211.

The display assembly 110 in this embodiment includes, for example, a display panel 111. The display panel 111 is, for example, a self-luminous display panel, such as an organic light-emitting diode panel. The display panel 111 is provided with a plurality of display areas 200. The information-displaying part 211 and the information-shielding part 212 each include a plurality of pixels 112. In this embodiment, for example, one sub-display area 210 includes pixels 112 arranged in a 10×10 array, but the invention is not limited thereto. In this embodiment, the information-displaying part 211 is configured to provide the image light beam L1, that is, to provide content to be displayed, such as a number on a button or other personal information. The pixels 112 corresponding to the information-shielding part 212 do not display meaningful content, for example, no light emission, or provide a meaningless symbol, such as messy code, but the invention does not specifically limit this.

As shown in FIG. 4, the microlens 121 is configured to project an image of the whole sub-display area 210. The projected projection light beam L2 includes a first part L21 corresponding to the information-displaying part 211 and a second part L22 corresponding to the information-shielding part 212. Because the information-shielding part 212 in the sub-display area 210 does not display meaningful content, the range covered by the second part L22 can be regarded as a non-visible area, while the range covered by the first part L21 can be regarded as a visible area. Because only the range covered by the first part L21 in the projection light beam L2 is regarded as the visible area, a viewing angle of the display device 100 can be reduced, and the peep-proof effect can be achieved. Therefore, when the display device 100 in this embodiment is used in a machine, the appearance of the machine is not required to be changed. Although the information-shielding part 212 in this embodiment is disposed on one side edge of the information-displaying part 211, the invention is not limited thereto and it can be adjusted as required.

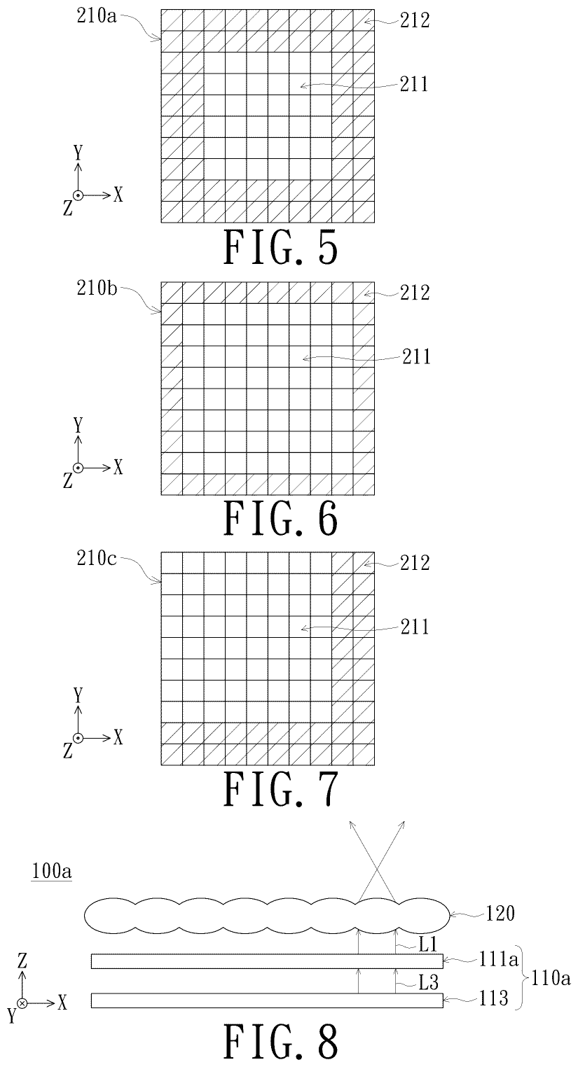

Continuing from the above, the information-shielding part 212 may be disposed beside at least one side edge of the information-displaying part 211. Specifically, the information-shielding part 212 may be disposed on two sides or three sides of the information-displaying part 211 or around the information-displaying part 211. FIG. 5 is a schematic diagram of a single sub-display area according to another embodiment of the invention. FIG. 6 is a schematic diagram of a single sub-display area according to another embodiment of the invention. FIG. 7 is a schematic diagram of a single sub-display area according to another embodiment of the invention. Refer to FIG. 5 first. An information-shielding part 212 of a sub-display area 210a in this embodiment, for example, surrounds the information-displaying part 211. The information-displaying part 211 is, for example, distributed in a middle area.

Refer to FIG. 6. FIG. 6 is similar to FIG. 5, and the main difference is that the distribution range of the information-displaying part 211 in a sub-display area 210b is larger than the distribution range of the information-displaying part 211 in the sub-display area 210a. Specifically, in this embodiment, for example, the area corresponding to the information-displaying part 211 is a visible area, and the range of the information-shielding part 212 in FIG. 6 is smaller than the range of the information-shielding part 212 in FIG. 5. Therefore, the viewing angle in this embodiment is slightly larger than the viewing angle in the embodiment in FIG. 5. Then, refer to FIG. 7. FIG. 7 is similar to FIG. 5, and the main difference is that the distribution range of the information-displaying part 211 in a sub-display area 210c is different from the distribution range of the information-displaying part 211 in the sub-display area 210a. Specifically, the information-shielding part 212 in this embodiment is, for example, arranged on both sides of the information-displaying part 211.

FIG. 8 is a schematic side view of a display device according to another embodiment of the invention. Refer to FIG. 1 and FIG. 8. A display device 100a in this embodiment is similar to the display device 100, and the main difference is that a display panel 111a of the display device 100a is, for example, a non-self-luminous display panel, such as a liquid crystal display panel, but the invention is not limited thereto. Continuing from the above, a display assembly 110a in this embodiment further includes, for example, a backlight module 113 disposed opposite to the display panel 111a. Specifically, the backlight module 113 is disposed, for example, on a side of the display panel 111a away from the microlens array 120. The backlight module 113 is, for example, suitable for providing an illumination light beam L3. The illumination light beam L3 penetrates the display panel 111a and is converted, for example, into an image light beam L1.

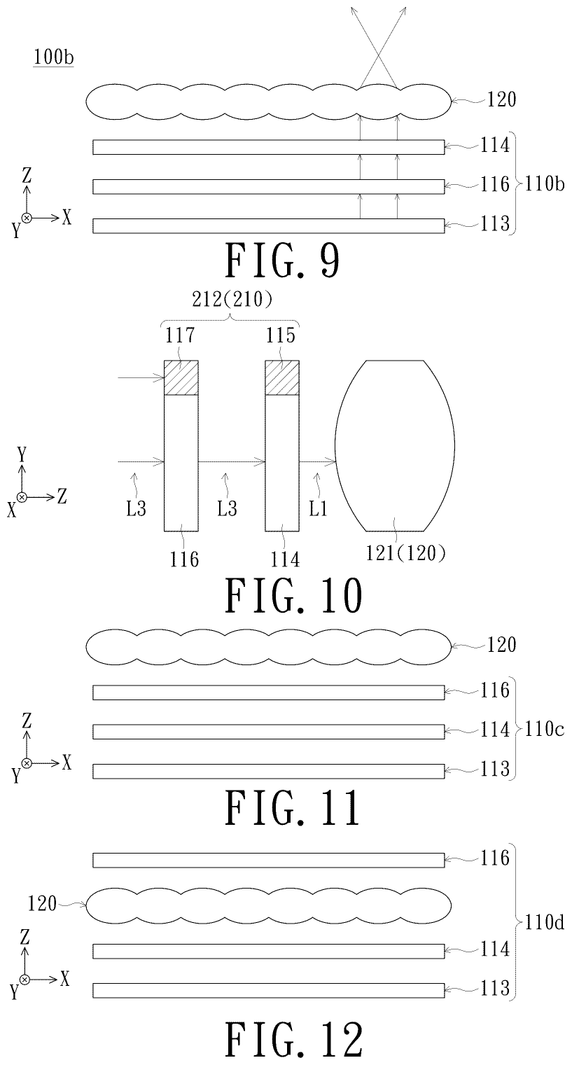

The display assembly in the above embodiment is exemplified by including a display panel, but the invention is not limited thereto as long as the display assembly is an assembly that can display specific information. FIG. 9 is a schematic side view of a display device according to another embodiment of the invention. FIG. 10 is a partially enlarged schematic diagram of the display device shown in FIG. 9. Refer to FIG. 9 and FIG. 10. A display assembly 110b in this embodiment includes, for example, a backlight module 113, an imaging sheet 114, and a shielding layer 116. The imaging sheet 114 is disposed, for example, between the microlens array 120 and the shielding layer 116. The shielding layer 116 is disposed, for example, between the imaging sheet 114 and the backlight module 113. The imaging sheet 114 is provided with, for example, a plurality of display areas 200 similar to the display areas 200 in FIG. 2, and the illumination light beam L3 is converted into an image light beam L1 after penetrating the imaging sheet 114. FIG. 10 is, for example, a schematic side view of a part of an imaging sheet 114 and a part of a shielding layer 116 corresponding to a single microlens 121 in a third direction Z; that is, the imaging sheet 114 in FIG. 10 is, for example, a single sub-display area 210 in a second direction Y. The distribution manners of the information-displaying part 211 and the information-shielding part 212 in this embodiment are, for example, the same as the distribution manner in FIG. 3.

In this embodiment, the information-shielding part 212 of each sub-display area 210 is provided with, for example, a light-shielding pattern 115, and the shielding layer 116 is provided with, for example, a plurality of shielding patterns 117. The shielding patterns 117 are respectively opposite to the information-shielding parts 212 of the sub-display areas 210. Specifically, the imaging sheet 114 in this embodiment is provided with, for example, the light-shielding pattern 115 suitable for shielding the illumination light beam L3. The light-shielding pattern 115 corresponds, for example, to the information-shielding part 212. The shielding patterns 117 of the shielding layer 116 are, for example, also suitable for shielding light beams, and the shielding patterns 117 are, for example, corresponding to the information-shielding part 212. In this embodiment, the distribution manners of the light-shielding patterns 115 and the shielding patterns 117 can be adjusted according to the area of the information-shielding part 212 to change the range of a visible area, thereby achieving the anti-peeping effect. The imaging sheet 114 is, for example, a photosensitive sheet, but the invention does not specifically limit this. In another embodiment, the imaging sheet 114 may be a photomask.

It should be noted that a display assembly 110b in this embodiment includes, for example, an imaging sheet 114 and a shielding layer 116, and the illumination light beam L3 is shielded, for example, by using the shielding patterns 117. However, the invention is not limited thereto. In another embodiment, the display assembly 110b may not include the shielding layer 116, and the illumination light beam L3 may be shielded, for example, by using the light-shielding pattern 115 of the imaging sheet 114. In another embodiment, the display assembly 110b may include the imaging sheet 114 and the shielding layer 116, but the imaging sheet 114 is, for example, not provided with the light-shielding pattern 115. In this case, the information-shielding part 212 of the display assembly 110b shields the light beam by using, for example, the shielding patterns 117 of the shielding layer 116.

FIG. 11 is a schematic side view of a display device according to another embodiment of the invention. FIG. 12 is a schematic side view of a display device according to another embodiment of the invention. Refer to FIG. 11 first. A display assembly 110c in this embodiment is similar to the display assembly 110b in FIG. 9, and the main difference is that a shielding layer 116 is disposed at a different position. Specifically, the shielding layer 116 of the display assembly 110c is disposed, for example, between the imaging sheet 114 and the microlens array 120. Then, refer to FIG. 12. A display assembly 110d in this embodiment is also similar to the display assembly 110b in FIG. 9, and the main difference is that a shielding layer 116 is disposed at a different position. Specifically, the shielding layer 116 is disposed, for example, on the side of the microlens array 120 away from the imaging sheet 114.

It is worth mentioning that the transmission path of the light beam may be affected by the microlens array 120. Thus, when the predetermined viewing angles are the same (that is, the distribution manner of the first part L21 corresponding to the information-displaying part 211 and the distribution manner of the second part L22 corresponding to the information-shielding part 212 are the same) but the relative positions among the imaging sheet 114, the shielding layer 116, and the microlens array 120 are different, the distribution manners of the light-shielding patterns 115 and/or the shielding patterns 117 may be adjusted, but the invention does not specifically limit this.

In summary, the sub-display area includes the information-displaying part and the information-shielding part, the viewing angle can be reduced by using the information-shielding part, and the viewing angle of a display device can be changed by adjusting the distribution mode for the information-displaying part and the information-shielding part. Thus, the display device in the invention adopting the sub-display area can have an anti-peeping effect.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A display device, comprising:
a display assembly, provided with a plurality of display areas, wherein each of the display areas is divided into a plurality of sub-display areas, each of the sub-display areas comprises an information-displaying part and an information-shielding part, and the information-shielding part is located beside the information-displaying part; and
a microlens array, disposed opposite to the display assembly, wherein the microlens array comprises a plurality of microlenses respectively opposite to the sub-display areas.

2. The display device according to claim 1, wherein the display assembly comprises a display panel, the display panel is provided with the display areas, and the information-displaying part and the information-shielding part each comprise a plurality of pixels.

3. The display device according to claim 2, wherein the display assembly further comprises a backlight module disposed opposite to the display panel.

4. The display device according to claim 1, wherein the display assembly comprises:
a backlight module; and
an imaging sheet, disposed between the microlens array and the backlight module, wherein the imaging sheet is provided with the display areas.

5. The display device according to claim 4, wherein the display assembly further comprises a shielding layer disposed between the imaging sheet and the backlight module, the shielding layer is provided with a plurality of shielding patterns, and the shielding patterns are respectively opposite to the information-shielding parts of the sub-display areas.

6. The display device according to claim 4, wherein the display assembly further comprises a shielding layer disposed between the imaging sheet and the microlens array, the shielding layer is provided with a plurality of shielding patterns, and the shielding patterns are respectively opposite to the information-shielding parts of the sub-display areas.

7. The display device according to claim 4, wherein the display assembly further comprises a shielding layer disposed on one side of the microlens array away from the imaging sheet, the shielding layer is provided with a plurality of shielding patterns, and the shielding patterns are respectively opposite to the information-shielding parts of the sub-display areas.

8. The display device according to claim 4, wherein the information-shielding part of each of the sub-display areas is provided with a light-shielding pattern.

9. The display device according to claim 1, wherein the information-shielding part is disposed beside at least one side edge of the information-displaying part.

10. The display device according to claim 1, wherein the information-shielding part surrounds the information-displaying part.
